(19) United States
(12) Patent Application Publication
(10) Pub. No.: US 2004/0050857 A1
(43) Pub. Date: Mar. 18, 2004

(54) Dispenser for folded web articles

(75) Inventor: David A. Norton, Tampa, FL (US)

Correspondence Address: DAVID KIEWIT, 5901 THIRD ST SOUTH, ST PETERSBURG, FL, 33705, US

(73) Assignee: Bay-Tek, Inc., Pulaski, WI

(21) Appl. No.: 10/655,207

(22) Filed: Sep. 4, 2003

Related U.S. Application Data
(60) Provisional application No. 60/411,586, filed on Sep. 18, 2002.

(51) Int. Cl. B65H 3/08; G07F 11/10

(52) U.S. Cl. 221/211; 221/232

(57) ABSTRACT

A device for dispensing folded sheets of material, such as a paper napkin, provides a selected time interval between successive dispensing operations in order to limit the overall rate at which the product is dispensed. The device uses a reciprocatable vacuum head for picking a napkin from a supply stack controlled to have an uppermost article at a selected height, and for then delivering the napkin to a delivery chute. The dimensions of the device can be matched the size of the napkin so that the vacuum head travels high that even if the napkin partially unfolds, it does not contact any portion of the device that could soil it or that it could jam. The vacuum head may be driven by a swing-arm linkage coupled to a crank turned by an electric gearmotor once per delivery cycle.

### FIELD OF THE INVENTION

This invention generally relates to dispensing devices and systems. More specifically, this invention relates to the field of devices and systems for dispensing folded sheets of material such as a paper napkin.

### BACKGROUND

Manual dispensers for gratuitously dispensed individual folded webs such as paper napkins are often provided at quick service food restaurants. Conventional paper napkin dispensers often provide poor one-at-a-time dispensing of folded napkins, and commonly permit removal of large clumps of napkins at one time. When clumps of napkins are taken, dispensers quickly run out and must be refilled, thus inconveniencing customers and increasing the costs of restaurant operators. Moreover, when an oversized clump of paper napkins is removed from a dispenser, there is a good chance that most of these will go unused and will contribute to the operator's cleaning costs by requiring employees to pick up and dispose of the wasted napkins.

### SUMMARY OF THE INVENTION

One of the features of the invention is the provision of a method for dispensing a single folded web, such as a napkin, per user request, wherein a selected time interval between successive dispensing operations limits the overall rate at which the folded webs are dispensed. In a preferred embodiment the user request comprises an act of actuating a momentary contact electrical switch without having to make a monetary payment, and the selected time interval is determined by a selected rate at which the napkin is conveyed, the selected rate preferably determined by a speed reduction ratio of a transmission interposed between an electric motor and an output shaft arranged to make a single revolution before tripping a shut off switch.

Another feature of the invention is the provision of apparatus comprising a reciprocatable vacuum head for picking a folded web article, such as a paper napkin, from a supply stack of generally horizontally disposed articles, where the stack is controlled to have an uppermost article disposed at a selected height, and for then delivering the article to a delivery chute. In a particular preferred embodiment, the supply stack is accessible from a first, back, end of the apparatus and the delivery chute is adjacent the second, front, end of the apparatus, and the apparatus is controlled to position the vacuum head above the delivery chute between delivery operations so that an operator can secure unimpeded access to the magazine stack.

In some preferred embodiments, apparatus of the invention is configured to deliver a folded web article, having predetermined dimensions, from a stack of the articles to a delivery chute by means of a reciprocating vacuum pick-up and carrier head arranged to move from the stack to the chute while always remaining elevated, so that if a folded article being conveyed to the chute unfolds no part of that article comes into contact with other parts of the apparatus.

In some preferred embodiments, apparatus of the invention comprises a slanted cover extending substantially from a stack of folded web articles having predetermined dimensions, such as napkins, to a delivery chute so that if a folded article being conveyed from the stack to the chute by means of a reciprocating vacuum pick-up and carrier head arranged unfolds, the slanted cover ensures that no part of that article comes into contact with parts of the apparatus other than the head and the slanted cover.

Although it is believed that the foregoing rather broad recital of features and technical advantages may be of use to one who is skilled in the art and who wishes to learn how to practice the invention, it will be recognized that the foregoing recital is not intended to list all of the features and advantages. Those skilled in the art will appreciate that they may readily use both the underlying ideas and the specific embodiments disclosed herein as a basis for designing other arrangements for carrying out the same purposes of the present invention. Those skilled in the art will realize that such equivalent constructions are within the spirit and scope of the invention in its broadest form. Moreover, it may be noted that various embodiments of the invention may provide various combinations of the hereinbefore recited features and advantages of the invention, and that less than all of the recited features and advantages may be provided by some embodiments.

### DESCRIPTION OF THE DRAWING

FIG. 1 is an elevational view of a preferred embodiment of the invention

FIG. 2 is a partially schematic detail elevational of a portion of a magazine stack used in the apparatus of the invention where two of four enclosure pieces have been removed in the interest of clarity.

FIG. 3 is a detail end view of a preferred mechanism for moving a vacuum pick-up head of the apparatus in a reciprocating fashion.

FIG. 4 is a schematic flow chart depicting a preferred method of operation of apparatus of the invention.

### DETAILED DESCRIPTION

In studying this Detailed Description, the reader may be aided by noting definitions of certain words and phrases used throughout this patent document. Wherever those definitions are provided, those of ordinary skill in the art should understand that in many, if not most instances, such definitions apply to prior, as well as future uses of such defined words and phrases. At the outset of this Description, one may note that the terms “include” and “comprise,” as well as derivatives thereof, mean inclusion without limitation; and the term “or,” is inclusive, meaning and/or.

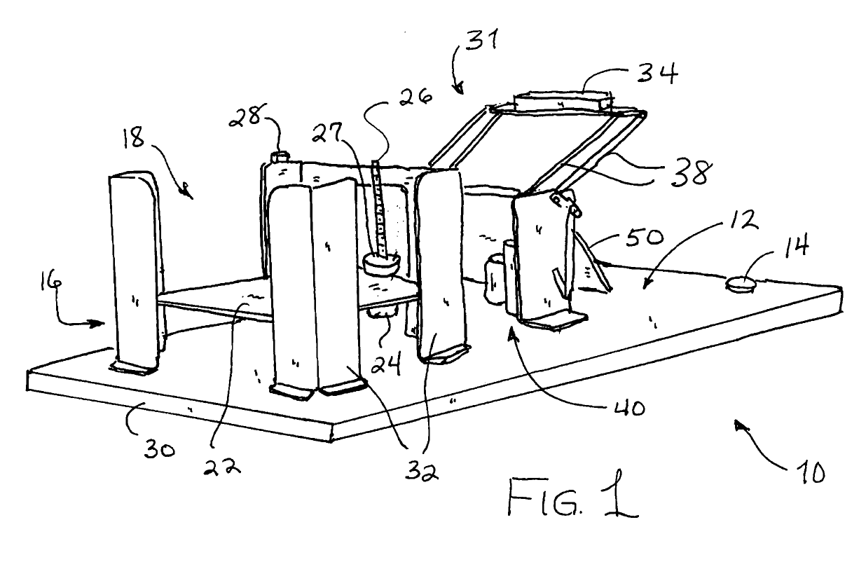

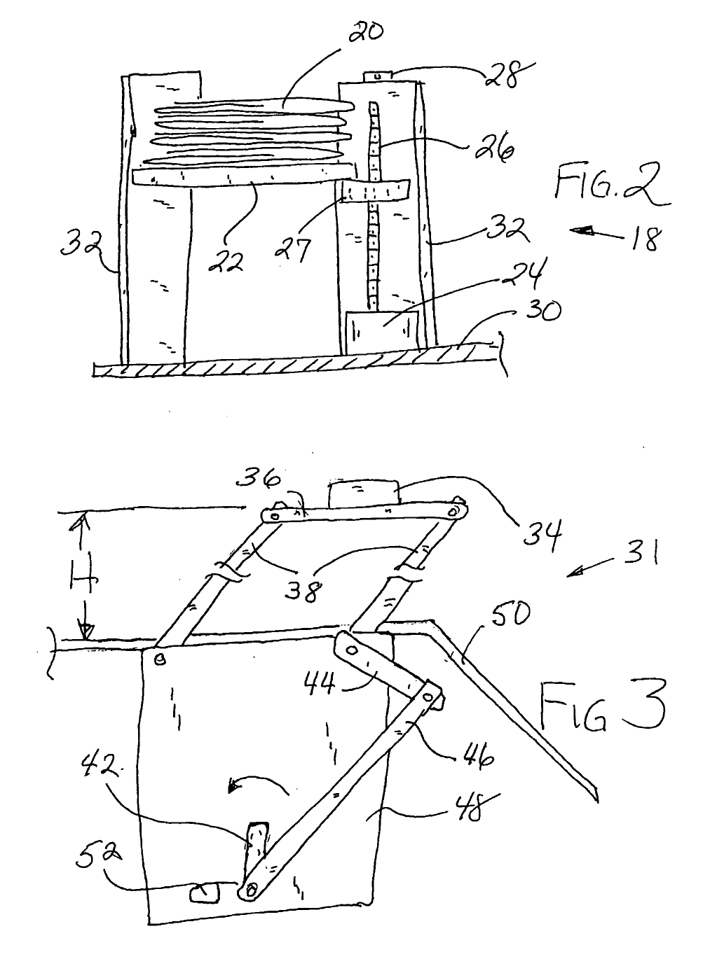

An overall view of a major portion of a preferred apparatus of the invention 10 is shown in FIG. 1. Inasmuch as the apparatus 10 is intended for use in a public area, it will be understood that a housing (not shown) will cover much of the apparatus, leaving little other than a delivery area 12 and a start button 14 of the mechanism exposed to public view. A preferred housing will have a suitable hinged door at the back end 16 of the apparatus so that an operator can gain access to a magazine 18 in order to reload it with napkins 20 as required. Although a preferred start button 14 comprises a momentary contact electromechanical switch, those skilled in the art will recognize that many other sorts of user actuation devices may be used and that these include a variety of switches, as well as capacitive or photoelectric proximity sensors having an output indicative of the user's request (e.g., the presence of the user's finger on the start button).

Although many conventional napkin dispensers employ a spring-biased arrangement for delivering napkins from a magazine, preferred embodiments of the invention employ a lift platform 22 raised and lowered by means of a motor 24 and feed screw 26 connected to the lift platform 22 by means of a lift nut 27. When this electromechanical arrangement is used in combination with a suitable position sensor 28, the height of the uppermost napkin 20 above the base plate 30 can be controlled to be at a selected height. The position sensor 28 may comprise a photoemitter-photodetector pair used in a reflective mode, as is well known in the control arts, or may be any of several other known position sensors using photoelectric, capacitive, ultrasonic, or other suitable sensing techniques. In a preferred embodiment, control of the lift platform height is independent of the operation of the napkin pick-and-place portion 31 of the apparatus. That is, whenever the apparatus 10 is in normal service, the lift platform is controlled by a conventional controller (not shown) to travel upwards until the uppermost napkin on the stack is detected by the position sensor 28, at which point the lift motor 24 is turned off. In order to assure an adequate supply of napkins, it is expected that an indicator light (not shown) will be illuminated when the lift platform reaches a pre-selected height, which may be detected by a limit switch or other known means. When the magazine 18 is to be reloaded, the lift platform must, of course, be lowered. This part of the operation can be controlled by various means, which include, but are not limited to a manually operated switch, or a switch operated by opening a door (not shown) on the back of the housing. Although the preferred approach to controlling the lift platform height is more or less independent of the pick-and-place 31 operation, it will be understood that one could also couple the two operations and elect to have the lift motor raise the platform while the pickup head was moving from its delivery position to its pick-up position. It will be recognized that a coupled arrangement of this sort could operate in a calibrated open loop fashion in which the lift platform is raised by an amount equal to a folded napkin thickness on each actuation of the dispenser. Although this would avoid having to use a position sensor and controller, it is expected that performance of the calibrated open loop arrangement would be inferior to that of preferred embodiment.

A preferred magazine comprises four enclosure pieces 32 configured to keep the generally rectangular napkins from falling laterally off the stack. The enclosure pieces 32 also provide tracks (not shown) for the lift platform 22.

Preferred embodiments of the invention use a vacuum head 34, comprising an electrically powered vacuum pump or blower as the vacuum source, to pick the uppermost napkin off the top of the stack and to convey it to an end-of-travel point above the delivery area 12, at which point the vacuum source is turned off and the napkin falls under the influence of gravity onto the delivery area. Although merely turning off the motor and allowing it to coast to a halt will drop the napkin, in a preferred embodiment a motor brake (not shown) of any of a number of known varieties is used to stop the motor more quickly and to thereby decrease the time that a user has to wait for the napkin to be delivered. Those skilled in the art will appreciate that other approaches to making a vacuum pick up head could be employed. These include, but are not limited to, the use of a vacuum blower affixed to the base plate and connected to a vacuum head by means of a flexible tube.

The vacuum head 34 may be supported on a plate 36 extending substantially across the width of the magazine 18 and pivotally connected at each of its two ends to a respective pair of parallel swing arms 38. In a preferred arrangement, one of the four swing arms is drivingly coupled to a gearmotor 40 by means of a crank 42 cooperating with upper 44 and lower 46 linkage members. The coupling arrangement is designed so that for each complete rotation of the crank 42, the vacuum head 34 executes a single complete motion back and forth along the length of the apparatus 10 from a delivery position above the delivery area 12, to a pick-up position, where it engages the uppermost napkin on the stack, and then back to the delivery position.

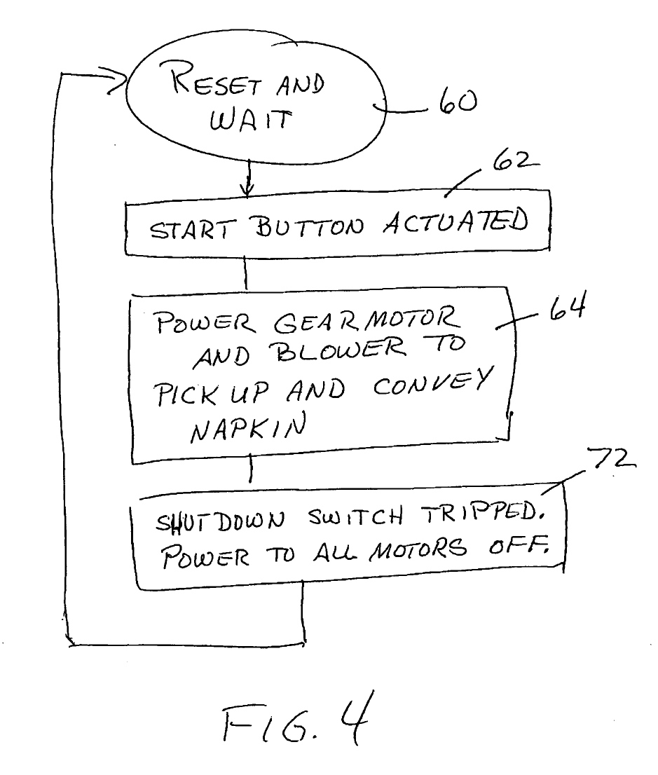

Because a napkin being conveyed from the magazine to the delivery position may unfold and allow a portion of the napkin to dangle beneath the pickup head, the dimensions of a preferred embodiment of the invention are selected so that the height (shown as “H” in FIG. 3) of the vacuum head 34 above any fixed portion of the pick-and-place portion 31 of the dispenser (e.g., an end support 48) is greater than the maximum fold length for whatever napkin variety the apparatus is to dispense. In the depiction of FIG. 3, this critical height is somewhat less than the length of one of the swing arms. Those skilled in the art will recognize that at least some of the moving parts of the pick-and-place portion of the apparatus, such as the swing arms, are necessarily closer than the height limit to the vacuum head.

Moreover, a preferred embodiment of the invention provides a protective cover 50 extending from the magazine to a point adjacent the delivery area 12 and generally providing a highest surface of the fixed portion of pick-and-place portion of the apparatus. This cover 50 ensures that even if a napkin unfolds more than is expected (or if a napkin having a longer fold length than is anticipated is used with the apparatus) the unfolded napkin will be prevented from getting tangled in, or picking up dirt or lubricants from, the apparatus 10.

In a preferred embodiment, a shutoff switch 52 is disposed adjacent the crank arm 42 and is actuated by the rotating mechanism at the end of a rotation so as to remove power from the gearmotor and allow the drive mechanism to coast to a halt. Alternately, a brake (not shown) of any of a number of known varieties, can be used to stop the drive mechanism. This alternate approach can be used if one wishes to stop the delivery mechanism at a precisely controlled location. The combination of the start switch 14, a latching relay (not shown) for powering the motor whenever the start switch is pressed, and the stop switch 52 thus provide a variation of a well known ‘single turn’ drive mechanism to deliver a single napkin for each actuation of the start switch. Those skilled in the control arts will recognize that many other control arrangements can be used to provide the same operational features, but the one recited above is simple, reliable, and well known. Such other control arrangements include, but ate not limited to, the use of a capacitive or photosensitive proximity detector to serve as a start button; the use of a computer-based control system for starting and stopping the mechanism; and the use of an angular position transducer, such as a shaft encoder, for indicating that a napkin has been dispensed so that the controller can stop the dispenser.

Turning now to FIG. 4, one finds a flow chart schematically depicting a sequence of steps carried out by various portions of the apparatus of the invention during the course of a single delivery cycle. As noted above, the vacuum head 34 is in the delivery position at the beginning of the cycle (Step 60). When the start button is actuated (Step 62), power is supplied to the gearmotor 40 and the vacuum blower (Step 64). The gearmotor then drives the vacuum head to the pick-up position and from there back to the delivery position at which point a portion of the drive mechanism trips the shutoff switch (52), which removes power from all the motors 24, 40 and the vacuum blower, which causes the conveyed napkin to fall onto the delivery area 12 (Step 72).

If a user desires more than one napkin, he or she may repeatedly push the start button in order to receive them. The napkins will be delivered at a delivery rate determined by the selected rate at which the pick-and-place portion of the dispenser conveys napkins from the stack to the position above the delivery point. This delivery rate may be selected to be long enough that a user experiences an easily perceptible delay subsequent to each request for a napkin and is thereby motivated to request no more napkins than are necessary. It will be understood that the delivery rate is preferably selected to be fast enough that a user does not become impatient and frustrated by the total wait time required to obtain a few napkins.

Although the present invention has been described with respect to several preferred embodiments, many modifications and alterations can be made without departing from the invention. Accordingly, it is intended that all such modifications and alterations be considered as within the spirit and scope of the invention as defined in the attached claims.

What is claimed is:

1) A dispenser for dispensing individual folded webs from a stack thereof, each of the webs having a common fold length, the dispenser comprising:
a start button for use by a user of the dispenser to initiate a dispensing operation;
a stack feed mechanism operable to maintain an uppermost web in the stack thereof at a selected height; and
a pick-and-place portion comprising:
a reciprocatable carrier for engaging the uppermost web, lifting the uppermost web from the stack thereof, and conveying the lifted web from the stack to a location immediately above a delivery position, the carrier comprising a vacuum pickup head vertically spaced apart from a fixed portion of the pick-and-place portion of the dispenser by more than the common fold length, whereby an unfolded web carried by carrier does not touch the fixed portion; and
an electric motor for reciprocating the carrier exactly once when the start button is actuated by the user.

2) The dispenser of claim 1 wherein the vacuum head is pivotally connected to at least one swing arm.

3) The dispenser of claim 1 further comprising a vacuum source adjacent to and arranged for motion with the vacuum pickup head.

4) The dispenser of claim 1 further comprising a stop switch for disconnecting the motor from a power source, the stop switch actuated by one of the crank and the at least one swing arm once during each rotation of the crank.

5) The dispenser of claim 1 wherein the motor is drivingly connected to a crank coupled to at least one swing arm that is pivotally connected to the carrier.

6) The dispenser of claim 1 further comprising a smooth cover extending between the stack and the position above the delivery point, the cover for preventing a conveyed web from contacting the fixed portion of the pick-and-place portion of the dispenser.

7) A method of dispensing a napkin to a user thereof, the method comprising the steps of:
a) providing a start button for use by the user to request a napkin;
b) turning on an electric motor responsive to an input from the start button, the electric motor acting to move a pickup head from a pickup position above a stack of the napkins to a position above a delivery point;
c) conveying, at a selected rate, an uppermost napkin from the stack thereof, by means of the pickup head, to the position above the delivery point;
d) stopping the motion of the pickup head at the position above the delivery point; and
e) causing the conveyed napkin to fall to the delivery point under the influence of gravity.

8) The method of claim 7 wherein the step of stopping the motion of the pickup head comprises tripping, by means of a mechanism interposed between the motor and the pickup head, a shutoff switch when the pickup head is at the position above the delivery point.

9) The method of claim 7 further comprising additional napkin-feeding steps, carried out independently of steps b) through f) of measuring the height of the uppermost napkin in the stack thereof by means of a position sensor and, if the height is less than a selected height, operating a second electric motor to raise a lift platform disposed beneath the stack of napkins until the uppermost napkin attains the selected height and thereafter shutting off the second electric motor.

10). The method of claim 7 wherein the pickup head comprises a vacuum pick up head having an electrically powered vacuum source operatively associated therewith and the step of causing the napkin to fall to the delivery point comprises turning off the vacuum source.

11) The method of claim 7 further comprising a step of repeating steps b) through e) each time the user uses the start button whereby a plurality of napkins are dispensed to the user at a delivery rate determined by the selected rate at which each napkin is conveyed.
